(19) United States
(12) Patent Application Publication
(10) Pub. No.: US 2026/0212795 A1
(43) Pub. Date: Jul. 23, 2026

(54) GAMMA VOLTAGE GENERATION CIRCUIT AND SOURCE DRIVER CIRCUIT

(71) Applicant: LX Semicon Co., Ltd., Daejeon (KR)

(72) Inventor: Byeong Ho JEONG, Daejeon (KR)

(73) Assignee: LX Semicon Co., Ltd., Daejeon (KR)

(21) Appl. No.: 19/136,637

(22) PCT Filed: Dec. 6, 2023
(86) PCT No.: PCT/KR2023/019989

§ 371 Date: Jun. 6, 2025

(30) Foreign Application Priority Data
Dec. 8, 2022 (KR) 10-2022-0170423
Nov. 24, 2023 (KR) 10-2023-0165266

(51) Int. Cl. G09G 3/20

(52) U.S. Cl. CPC G09G 3/2007; G09G 2310/027; G09G 2320/0673; G09G 2330/021

(57) ABSTRACT

The present invention relates to a gamma voltage generation circuit and a source driver circuit, comprising: a first voltage divider configured to output a plurality of voltages having different voltage levels between a high potential reference voltage and a low potential reference voltage; a plurality of amplifiers configured to transmit the voltages output from the first voltage divider to output terminals as gamma voltages; a second voltage divider connected between the high potential reference voltage and the low potential reference voltage and connected to the output terminals of the amplifiers; and at least one self-driver connected to the second voltage divider to adjust at least one gamma voltage other than the gamma voltages output from the amplifiers.

### TECHNICAL FIELD

The present invention relates to a gamma voltage generation circuit and a source driver circuit.

### BACKGROUND ART

A variety of flat panel displays are known, including electroluminescence displays (ELD) such as liquid crystal displays (LCD) and organic light-emitting diode (OLED) displays, field emission displays (FED), plasma display panels (PDP), and electrophoresis displays (EPD).

A display device includes a display panel having pixels arranged therein that display an input image, and a display panel driver circuit that writes data to the pixels in the display panel. The display panel driver circuit includes a data driver circuit that supplies data signals of source data to the data lines of the display panel, and a gate driver circuit that supplies gate signals to the gate lines of the display panel.

The display panel driver circuit further includes a gamma voltage generation circuit that supplies a gamma voltage to the data driver circuit. The gamma voltage generation circuit includes many buffer amplifiers, resulting in large circuit area, and generates high peak voltages when a transition width of a data voltage is large, leading to increased heat and power consumption. Since an intermediate gray-scale voltage output from the gamma voltage generation circuit is generated by driving the buffer amplifiers and voltage divider circuits, there is a problem that a settling time to reach a target voltage is long.

### DISCLOSURE

### Technical Problem

The present invention provides a gamma voltage generation circuit and a source driver circuit that may reduce circuit size and improve heat generation, power consumption, and settling time.

### Technical Solution

A gamma voltage generation circuit according to an embodiment of the present invention includes: a first voltage divider configured to output a plurality of voltages having different voltage levels between a high potential reference voltage and a low potential reference voltage; a plurality of amplifiers configured to transmit the voltages output from the first voltage divider to output terminals of the amplifiers as gamma voltages; a second voltage divider connected between the high potential reference voltage and the low potential reference voltage and connected to the output terminals of the amplifiers; and one or more self-drivers connected to the second voltage divider to adjust at least one of gamma voltages other than the gamma voltages output from the amplifiers. The self-drivers include a first transistor and a second transistor connected in series.

The first transistor may be an n-channel transistor and the second transistor may be a p-channel transistor.

The first transistor may include a gate electrode connected to an (i)th gamma voltage, a first electrode connected to a driving voltage, and a second electrode connected to an (i+1)th gamma voltage, where i is a natural number. The second transistor may include a gate electrode connected to an (i+2)th gamma voltage, a first electrode connected to the (i+1)th gamma voltage, and a second electrode connected to a ground voltage.

The (i)th gamma voltage may be higher than the (i+1)th gamma voltage, and the (i+2)th gamma voltage may be lower than the (i+1)th gamma voltage.

The first transistor may include a gate electrode connected to a voltage division node of the first voltage divider, a first electrode connected to a driving voltage, and a second electrode connected to an (i+1)th gamma voltage corresponding to a voltage output from the voltage division node, where i is a natural number. The second transistor may include a gate electrode connected to the voltage division node of the first voltage divider, a first electrode connected to the (i+1)th gamma voltage, and a second electrode connected to a ground voltage.

The first transistor may include a gate electrode connected to a voltage division node of the first voltage divider, a first electrode connected to an (i)th gamma voltage, and a second electrode connected to an (i+1)th gamma voltage corresponding to a voltage output from the voltage division node, where i is a natural number. The second transistor includes a gate electrode connected to the voltage division node of the first voltage divider, a first electrode connected to the (i+1)th gamma voltage, and a second electrode connected to an (i+2)th gamma voltage.

The (i)th gamma voltage may be higher than the (i+1)th gamma voltage, and wherein the (i+2)th gamma voltage may be lower than the (i+1)th gamma voltage.

The gamma voltage generation circuit may further include: a first switch element connected to the gate electrode of the first transistor to selectively disable the first transistor; and a second switch element connected to the gate electrode of the second transistor to selectively disable the second transistor.

A source driver circuit according to an embodiment of the present invention includes the gamma voltage generation circuit.

### Effect of the Invention

The present invention may reduce the settling time of the gamma voltage without adding an amplifier by using a self-driver using two transistors. As a result, the present invention may reduce the circuit size of the gamma voltage generation circuit and the source driver circuit, and improve the heat generation, power consumption, and settling time.

The present invention may reduce the settling time or speed of the gamma voltage without reducing a resistance value or increasing a power of the voltage divider circuit and without consuming a constant current, resulting in an increase in a response time and slew rate of the gamma voltage and the data voltage output from the source driver when a grayscale value of the source data changes.

The effects of the present invention are not limited to the above-mentioned effects, and other effects that are not mentioned will be apparently understood by those skilled in the art from the following description and the appended claims.

### BRIEF DESCRIPTION OF THE DRAWINGS

FIG. 1 is a block diagram illustrating a display device according to one embodiment of the present invention.

FIG. 2 is a block diagram that schematically shows a circuit of a data driver.

FIGS. 3 and 4 are circuit diagrams illustrating a gamma voltage generator according to the embodiment of the present invention.

FIGS. 5 and 6 are schematics illustrating a pre-driving of a self-driver.

FIG. 7A and FIG. 7B are simulation result diagrams verifying a peak voltage suppression effect of the self-driver along with comparative examples.

FIGS. 9 and 10 are circuit diagrams illustrating a gamma voltage generator according to another embodiment of the present invention.

FIG. 11 is a circuit diagram illustrating another example of driving voltage applied to the self-drivers shown in FIGS. 9 and 10.

FIG. 12 is a circuit diagram illustrating an example of additional switch elements connected to the self-drivers shown in FIGS. 9 and 10.

FIGS. 13 and 14 are circuit diagrams illustrating the pre-driving of the self-driver. and

FIG. 15 is a simulation result diagram verifying the peak voltage suppression effect of the self-driver shown in FIGS. 9 and 10.

### BEST MODE FOR CARRYING OUT THE INVENTION

A gamma voltage generation circuit according to one embodiment of the present invention comprises: a first voltage divider configured to output a plurality of voltages having different voltage levels between a high potential reference voltage and a low potential reference voltage; a plurality of amplifiers configured to transmit the voltages output from the first voltage divider to output terminals of the amplifiers as gamma voltages; a second voltage divider connected between the high potential reference voltage and the low potential reference voltage and connected to the output terminals of the amplifiers; and one or more self-drivers connected to the second voltage divider to adjust at least one gamma voltage other than the gamma voltages output from the amplifiers.

### MODE OF PRACTING THE INVENTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

In the following embodiments, a transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (PMOS), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. In the following description, a source and a drain of a transistor will be referred to as a first electrode and a second electrode.

Hereinafter, various embodiments of the present disclosure will be described in detail with reference to the accompanying drawings.

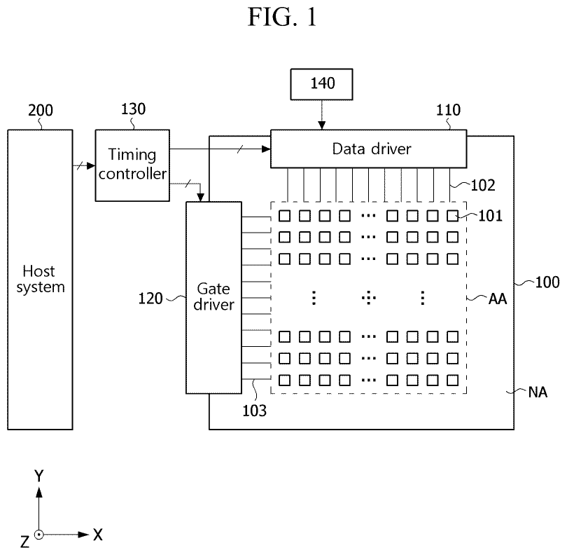

FIG. 1 is a block diagram illustrating a display device according to one embodiment of the present invention.

Referring to FIG. 1, the display device according to the embodiment of the present invention includes a display panel 100 and a display panel driver circuit for writing source data to pixels of the display panel 100. The source data may be interpreted as pixel data.

A substrate of the display panel 100 may be, but is not limited to, a plastic substrate, a thin glass substrate, or a metal substrate. The display panel 100 may be, but is not limited to, a panel having a rectangular structure with a length in a first direction, a width in a second direction, and a thickness in a third direction. X, Y, and Z in FIG. 1 may be a first direction, a second direction, and a third direction, respectively.

In the case of a liquid crystal display device, a back light unit (BLU) may be arranged below the display panel 100. In the case of a self-emitting display device such as an electroluminescent display device, a separate light source such as a back light unit is not required.

A display area AA of the display panel 100 includes a pixel array for displaying an input image thereon. The pixel array includes a plurality of data lines 102, a plurality of gate lines 103 intersecting with the data lines 102, and a plurality pixels 101 connected to the data lines 102 and the gate lines 103.

Each of the pixels 101 may be divided into a red sub-pixel, a green sub-pixel, and a blue sub-pixel for color implementation. Each of the pixels may further include a white sub-pixel. In a liquid crystal display device, the pixels include a liquid crystal cell. In an electroluminescent display device, the pixels include light-emitting elements such as OLED. Each of the sub-pixels includes a pixel circuit for driving the liquid crystal cell or the light-emitting element.

The display panel driver circuit writes the source data of the input image in the pixels in the display panel 100 under a control of a timing controller 130. The display panel driver circuit includes a source driver circuit that converts the source data to a data voltage and a gate driver 120. The source driver circuit includes a gamma voltage generator 140 and a data driver 110.

The display panel driving circuit may further include a touch sensor driver for driving touch sensors. The touch sensor driver is omitted from FIG. 1. In mobile devices or wearable devices, the timing controller 130, the data driver 110, the touch sensor driver, and the like may be integrated in a single driving IC.

The data driver 110 receives the source data of the input image received as a digital signal from the timing controller 130 to output the data voltage. The data driver 110 converts the source data of the input image into a gamma compensated voltage using a digital-to-analog converter (DAC) to output the data voltage.

The gamma voltage generator 140 generates a plurality of gamma voltages with different voltage levels and provides them to the data driver 110. The gamma voltage may be interpreted as a gamma reference voltage, or a gamma tab voltage. In the case of light-emitting elements, the emission efficiency may be different for each color. In accordance with such color-specific light-emitting efficiency characteristics, the gamma voltages may be divided into color-specific independent voltages according to the colors of the sub-pixels. The gamma voltage generator 140 may be included within the data driver 110 to form a source driver circuit.

The gamma voltages generated by the gamma voltage generator 140 are supplied to the data driver 110. The gamma voltages are divided by the data driver 110 into grayscale voltages corresponding to each grayscale of the source data and supplied to a DAC. The DAC converts the source data, which is a digital signal, into analog data voltages by outputting the grayscale voltages corresponding to the grayscale values of the source data using a plurality of transistors. The data voltage output from the DAC is output to the data line 102 through an output buffer in each of the data output channels of the data driver 110.

A circuit of the gate driver 120 may be arranged in a non-display area NA outside the display area AA in the display panel 100 or at least a portion thereof may be arranged in the display area AA. The gate driver 120 may be integrated into a separate gate driving IC and electrically connected to the gate lines 103 on the display panel 100.

The gate driver 120 sequentially outputs pulses of the gate signals to the gate lines under the control of the timing controller 130. The gate driver 120 may sequentially supply the pulses of the gate signals to the gate lines 103 by shifting the pulses of the gate signals using shift registers.

The timing controller 130 receives the source data of the input image and a timing signal synchronized with the data from an external host system 200. The timing signal may include a vertical synchronization signal Vsync, a horizontal synchronization signal Hsync, a data enable signal DE, and a main clock. A vertical period and a horizontal period may be known by counting the data enable signal DE, and thus the vertical synchronization signal Vsync and the horizontal synchronization signal Hsync may be omitted. The vertical synchronization signal Vsync has a cycle of one frame period. The horizontal synchronization signal Hsync and the data enable signal DE have a cycle of one horizontal period (1H).

The timing controller 130 controls an operation timing of the display panel driver circuits 110 and 120 based on the timing signals such as Vsync, Hsync, and DE received from the host system 200.

The host system 200 may scale an image signal from a video source to match a resolution of the display panel 100, and may transmit it to the timing controller 130 together with the timing control signal. In a mobile system, the host system 200 may be implemented by an application processor (AP). The host system 200 may transmit the source data of the input image to the driving IC through a mobile Industry Processor Interface (MIPI). The host system 200 may be electrically connected to the driving IC through a flexible printed circuit, for example, a flexible printed circuit (FPC). The driving IC may be bonded to the display panel 100 in a COG (Chip on Glass) process. The driving IC may be a chip on film (COF) mounted on a flexible circuit film. The COF may be bonded to data pads arranged on the non-display area of the display panel 100 in a bonding process and electrically connected to the data lines on the display panel 100.

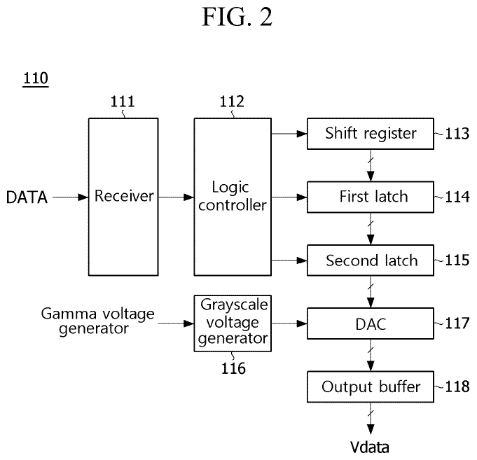

FIG. 2 is a block diagram that schematically shows the circuit of a data driver;

Referring to FIG. 2, the data driver 110 may include a receiver 111, a logic controller 112, a shift register 113, a first latch 114, a second latch 115, a grayscale voltage generator 116, a DAC 117, and an output buffer 118.

The receiver 111 receives serially received data DATA from the timing controller 130, restores a clock from the DATA, and uses the restored clock to sample the control data and the source data of the input image from the DATA to provide them to the logic controller 112. The timing controller 130 converts the clock and the data into low-voltage differential signals that may be transmitted to the data driver 110 via a high-speed serial interface.

The logic controller 112 rearranges pixel data supplied from the receiver 111 into sub-pixels. The logic controller 112 may supply a start pulse and the clock to the shift register 113 using the recovered clock and the control data, and control the output timing of the first and second latches 114 and 115 and the output buffer 118.

The shift register 113, the first latch 114, and the second latch 115 convert the pixel data in the serial scheme into data of parallel scheme. When the start pulse is input, the shift register 113 shifts the clock and outputs the shifted clock to the channels of the first latch 114. The first latch 114 samples the source data input from the receiver 111 through the logic controller 112 in response to the clock sequentially input from the shift register 113, and, when the source data is latched on all channels, outputs the latched data simultaneously to the channels of the second latch 115. The second latch 115 latches the data simultaneously received from the first latch 114 and outputs the latched data simultaneously to the DAC 117 in response to an output enable signal from the logic controller 112.

The grayscale voltage generator 116 receives a gamma voltage from the gamma voltage generator 140. The grayscale voltage generator 116 includes a voltage divider circuit using a plurality of resistors connected in series. The voltage divider circuit of the grayscale voltage generator 116 divides the gamma voltages and supplies grayscale voltages corresponding to each grayscale of the source data to the DAC 117.

The DAC 117 selects a grayscale voltage corresponding to a gray value of source data input from the second latch 115 and outputs the selected grayscale voltage as the data voltage Vdata. The data voltage Vdata is output through the output buffer 118 and applied to the data lines 102 of the display panel 100.

As the grayscale of the source data increases, the data voltage Vdata output through the DAC 117 to which the gamma voltage is applied may decrease. On the other hand, as the grayscale of the source data decrease, the data voltage Vdata output may increase.

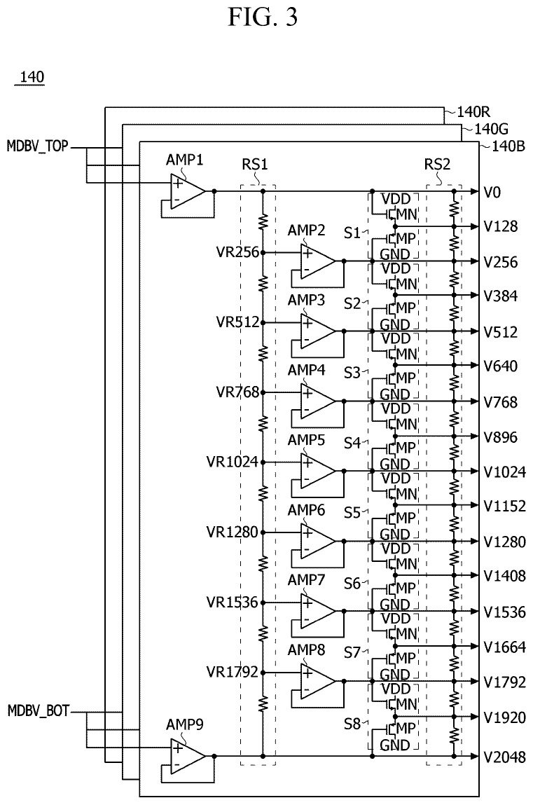

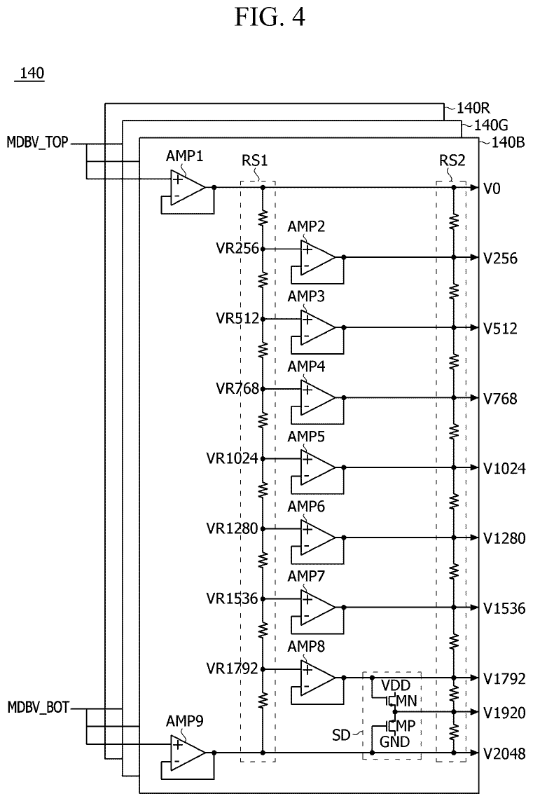

FIGS. 3 and 4 are circuit diagrams illustrating a gamma voltage generator 140 according to one embodiment of the present invention. Hereinafter, “Vn” is a gamma voltage corresponding to a grayscale value “n” of the source data.

Referring to FIGS. 3 and 4, the gamma voltage generator 140 includes a first voltage divider RS1 that is connected between a node to which a high potential reference voltage MDBV_TOP is applied and a node to which a low potential reference voltage MDBV_BOT is applied to output the high potential reference voltage MDBV_TOP and the low potential reference voltage MDBV_BOT, and a plurality of voltages VR256 to VR1792 having different voltage levels between the high potential reference voltage MDBV_TOP and a low potential reference voltage MDBV_BOT; a plurality of amplifiers AMP1 to AMP9 connected to the first voltage divider RS1; a second voltage divider RS2 that is connected between the node to which the high potential reference voltage MDBV_TOP is applied and the node to which the low potential reference voltage MDBV_BOT and connected to output terminals of the amplifiers AMP1 to AMP9; and one or more self-drivers S1 to S8 that are connected to the second voltage divider RS2 to lower at least one of gamma voltages V128, V384, V640, V896, V1152, V1408, V1664 and V1920 other than the gamma voltages V256, V512, V768, V1024, V1280, V1536, V1792 and V2048 output from the amplifiers AMP1 to AMP9.

In the case of a color-specific independent gamma circuit, the gamma voltage generator 140 may include, but is not limited to, a first gamma voltage generator 140R, a second gamma voltage generator 140G, and a third gamma voltage generator 140B. The first gamma voltage generator 140R outputs gamma voltages to generate the data voltage Vdata that is applied to the red sub-pixel. The second gamma voltage generator 140G outputs gamma voltages to generate the data voltage Vdata that is applied to the green sub-pixel. The third gamma voltage generator 140B outputs gamma voltages to generate the data voltage Vdata that is applied to the blue sub-pixel.

The high potential reference voltage MDBV_TOP, the low potential reference voltage MDBV_BOT, an amplifier driving voltage, and a self-driver driving voltage VDD are applied to the gamma voltage generator 140. The high potential reference voltage MDBV_TOP may be 6 V and the low potential reference voltage MDBV_BOT may be 2 V, but are not limited thereto. The high potential reference voltage MDBV_TOP and the low potential reference voltage MDBV_BOT may vary in voltage level when the brightness is regulated by the host system 200. For example, the low potential reference voltage MDBV_BOT may increase when the brightness decreases based on the illumination of the user interface or usage environment.

The gamma voltage generator 140 outputs a first to seventeenth gamma voltages V0 to V2048 having different voltage levels. The gamma voltages may be, but are not limited to, gamma voltages with a grayscale of 0 to a grayscale of 2048. In the gamma voltage generator 140, the gamma voltages output through neighboring output terminals have a certain voltage difference. The first gamma voltage V0 output from the gamma voltage generator 140 may be 6V, the ninth gamma voltage V1024 may be 3.5V, the seventeenth gamma voltage V2048 may be 1V, and the (n)th gamma voltage may be Vn=6V−(6V−1V)*n/2048), but is not limited thereto.

The first voltage divider RS1 includes a plurality of resistors connected in series. The first voltage divider RS1 divides the high potential reference voltage MDBV_TOP between the high potential reference voltage MDBV_TOP and the low potential reference voltage MDBV_BOT to generate voltages with different voltage levels VR256, VR512, VR768, VR1024, VR1280, VR1536 and VR1792 through voltage division nodes.

Amplifiers AMP1 to AMP9 may be interpreted as buffers or voltage followers including operational amplifiers. Each of the amplifiers AMP1 to AMP9 includes a non-inverting input terminal (+), an inverting input terminal (−), and an output terminal.

The first amplifier AMP1 outputs the high potential reference voltage MDBV_TOP input to its non-inverting input terminal (+) as the first gamma voltage V0. An inverting input terminal (−) and an output terminal of the first amplifier AMP1 are connected to a first output terminal of the gamma voltage generator 140 from which the first gamma voltage V0 is output. The ninth amplifier AMP9 outputs the low potential reference voltage MDBV_BOT input to its non-inverting input terminal (+) as the seventeenth gamma voltage V2048. An inverting input terminal (−) and an output terminal of the ninth amplifier AMP9 are connected to a seventeenth output terminal of the gamma voltage generator 140 from which the seventeenth gamma voltage V2048 is output. The dynamic range of the data voltage Vdata output from each channel of the data driver 110 is determined by the voltage range of the first gamma voltage V0 and the seventeenth gamma voltage V2048.

The second amplifier AMP2 outputs the voltage VR256 output from a first voltage division node of the first voltage divider RS1 as the third gamma voltage V256. A inverting input terminal (−) and a output terminal of the second amplifier AMP2 are connected to a third output terminal of the gamma voltage generator 140 from which the third gamma voltage V256 is output. The third amplifier AMP3 outputs the voltage VR512 output from a second voltage division node of the first voltage divider RS1 as the fifth gamma voltage V512. A inverting input terminal (−) and a output terminal of the third amplifier AMP3 are connected to a fifth output terminal of the gamma voltage generator 140 from which the fifth gamma voltage V512 is output. The fourth amplifier AMP4 outputs the voltage VR768 output from a third voltage division node of the first voltage divider RS1 as the seventh gamma voltage V768. A inverting input terminal (−) and a output terminal of the fourth amplifier AMP4 are connected to a seventh output terminal of the gamma voltage generator 140 from which the seventh gamma voltage V768 is output. The fifth amplifier AMP5 outputs the voltage VR1024 output from a fourth voltage division node of the first voltage divider RS1 as the ninth gamma voltage V1024. The inverting input terminal (−) and a output terminal of the fifth amplifier AMP5 are connected to a ninth output terminal of the gamma voltage generator 140 from which the ninth gamma voltage V1024 is output.

The sixth amplifier AMP6 outputs the voltage V1280 output from a fifth voltage division node of the first voltage divider RS1 as the eleventh gamma voltage V1280. An inverting input terminal (−) and an output terminal of the sixth amplifier AMP6 are connected to an eleventh output terminal of the gamma voltage generator 140 from which the eleventh gamma voltage V1280 is output. The seventh amplifier AMP7 outputs the voltage VR1536 output from a sixth voltage division node of the first voltage divider RS1 as the thirteenth gamma voltage V1536. An inverting input terminal (−) and an output terminal of the seventh amplifier AMP7 are connected to a thirteenth output terminal of the gamma voltage generator 140 from which the thirteenth gamma voltage V1536 is output. The eighth amplifier AMP8 outputs the voltage VR1792 output from a seventh voltage division node of the first voltage divider RS1 as the fifteenth gamma voltage V1792. An inverting input terminal (−) and an output terminal of the eighth amplifier AMP8 are connected to a fifteenth output terminal of the gamma voltage generator 140 from which the fifteenth gamma voltage V1792 is output.

The second voltage divider RS2 includes a plurality of resistors connected in series. The second voltage divider RS2 divides the first gamma voltage V0 between the first gamma voltage V0 and the seventeenth gamma voltage V2048. The second voltage divider RS2 may generate through voltage division nodes the second gamma voltage V128 having a voltage level between the first gamma voltage V0 and the third gamma voltage V256, the fourth gamma voltage V384 having a voltage level between the third gamma voltage V256 and the fifth gamma voltage V512, the sixth gamma voltage V640 having a voltage level between the fifth gamma voltage V512 and the seventh gamma voltage V 768, the eighth gamma voltage V896 having a voltage level between the seventh gamma voltage V768 and the ninth gamma voltage V1024, the tenth gamma voltage V1152 having a voltage level between the ninth gamma voltage V1024 and the eleventh gamma voltage V1280, the twelfth gamma voltage V1408 having a voltage level between the eleventh gamma voltage V1280 and the thirteenth gamma voltage V1536, the fourteenth gamma voltage V1664 having a voltage level between the thirteenth gamma voltage V1536 and the fifteenth gamma voltage V1792, and the sixteenth gamma voltage V1920 having a voltage level between the fifteenth gamma voltage V1792 and the seventeenth gamma voltage V2048, but is not limited thereto.

The gamma voltage generator 140 uses self-drivers S1 to S8 that are pre-driven when a peak voltage of the data voltage Vdata occurs to reduce the peak voltage, thereby enabling the data voltage Vdata to quickly reach a target grayscale voltage when the grayscale of the source data changes. The gamma voltage generator 140 may include first to eighth self-drivers S1 to S8, as shown in FIG. 3.

Each of the self-drivers S1 to S8 may lower a peak voltage of an (i+1)th gamma voltage by using transistors MN and MP that are self-driven in response to a peak voltage of an (i)th (i is a natural number) gamma voltage and an (i+2)th gamma voltage. The (i+1)th gamma voltage is a voltage lower than the (i)th gamma voltage and higher than the (i+2)th gamma voltage. The driving voltage VDD of the self-drivers S1 to S8 may be 8 V and the ground voltage GND may be 0 V, but is not limited thereto.

The first transistor MN may be an n-channel transistor and the second transistor MP may be a p-channel transistor. The first transistor MN is turned on when Vi−(Vi+1)>Vthn. Where Vi is the (i)th gamma voltage Vi. Vi+1 is a voltage lower than Vi and is the (i+1)th gamma voltage output through an output node between the first transistor MN and the second transistor MP. Vthn is a threshold voltage of the first transistor MN.

The second transistor MP turns on when (Vi+2)−(Vi+1)<Vthp. Here Vi+2 is the (i+2)th gamma voltage (Vi+2). Vthp is a threshold voltage of the second transistor MP.

The first transistor MN may include a gate electrode connected to an output terminal to which the (i)th gamma voltage is applied, a first electrode (drain) connected to a node to which the driving voltage VDD is applied, and a second electrode (source) connected to an output terminal to which the (i+1)th gamma voltage is applied. The second transistor MP may include a gate electrode connected to an output terminal to which the (i+2)th gamma voltage is applied, a first electrode (source) connected to the output terminal to which the (i+1)th gamma voltage is applied, and a second electrode (drain) connected to a node to which the ground voltage GND is applied.

Because the first and second transistors MN and MP are applied with gate-source voltages close to their respective threshold voltages Vthn and Vthp, when the grayscale of the source data changes causing the (i+1)th gamma voltage to vary, either one turns on even at a voltage lower than its own threshold voltage to lower the peak voltage of the (i+1)th gamma voltage. As a result, each of the self-drivers has the effect of lowering the threshold voltages Vthn and Vthp of the transistors, and this effect may be further enhanced as the voltage difference between the high-voltage threshold voltage MDVB_TOP and the low-voltage threshold voltage MDBV_BOT increases.

The first self-driver S1 includes first and second transistors MN and MP connected in series between the first gamma voltage V0 and a third gamma voltage V256. The first and second transistors MN and MP are connected in series between the driving voltage VDD and the ground voltage GND. The first transistor MN includes a gate electrode connected to the first gamma voltage V0, a first electrode (drain) connected to the driving voltage VDD, and a second electrode (source) connected to a second gamma voltage V128. When a falling peak voltage occurs on the second gamma voltage V128, the first transistor MN turns on to lower the peak voltage, thereby enabling the second gamma voltage V128 to quickly reach a target voltage. The second transistor MP includes a gate electrode connected to the third gamma voltage V256, a first electrode (source) connected to the second gamma voltage V128, and a second electrode (drain) connected to the ground voltage GND. When a rising peak voltage occurs on the second gamma voltage V128, the second transistor MP turns on to lower the peak voltage, thereby enabling the second gamma voltage V128 to quickly reach a target voltage.

The first transistor MN of the second self-driver S2 turns on when a falling peak voltage occurs on the fourth gamma voltage V384 to lower the peak voltage. The second transistor MP of the second self-driver S2 turns on when a rising peak voltage occurs on the fourth gamma voltage V384 to lower the peak voltage. The first transistor MN of the third self-driver S3 turns on when a falling peak voltage occurs on the sixth gamma voltage V640 to lower the peak voltage. The second transistor MP of the third self-driver S3 turns on when a rising peak voltage occurs on the sixth gamma voltage V640 to lower the peak voltage.

The first transistor MN of the fourth self-driver S4 turns on when a falling peak voltage occurs on the eighth gamma voltage V896 to lower the peak voltage. The second transistor MP of the fourth self-driver S4 turns on when a rising peak voltage occurs on the eighth gamma voltage V896 to lower the peak voltage. The first transistor MN of the fifth self-driver S5 is turned on when a falling peak voltage occurs on the tenth gamma voltage V1152 to lower the peak voltage. The second transistor MP of the fifth self-driver S5 turns on when a rising peak voltage occurs on the tenth gamma voltage V1152 to lower the peak voltage. The first transistor MN of the sixth self-driver S6 is turned on when a falling peak voltage occurs on the twelfth gamma voltage V1408 to lower the peak voltage. The second transistor MP of the sixth self-driver S6 is turned on when a rising peak voltage occurs on the twelfth gamma voltage V1408 to lower the peak voltage. The first transistor MN of the seventh self-driver S7 is turned on when a falling peak voltage occurs on the fourteenth gamma voltage V1664 to lower the peak voltage. The second transistor MP of the seventh self-driver S7 turns on when a rising peak voltage occurs on the fourteenth gamma voltage V1664 to lower the peak voltage.

The eighth self-driver S8 includes first and second transistors MN and MP connected in series between the fifteenth gamma voltage V1792 and the seventeenth gamma voltage V2048. The first transistor MN includes a gate electrode connected to the fifteenth gamma voltage V1792, a first electrode (drain) connected to the driving voltage VDD, and a second electrode (source) connected to the sixteenth gamma voltage V1920. When a falling peak voltage occurs on the sixteenth gamma voltage V1920, the first transistor MN turns on to lower the peak voltage, thereby enabling the sixteenth gamma voltage V1920 to quickly reach a target voltage. The second transistor MP includes a gate electrode connected to the seventeenth gamma voltage V2048, a first electrode (source) connected to the sixteenth gamma voltage V1920, and a second electrode (drain) connected to the ground voltage GND. When a rising peak voltage occurs on the sixteenth gamma voltage V1920, the second transistor MP turns on to lower the peak voltage, thereby enabling the sixteenth gamma voltage V1920 to quickly reach a target voltage.

Some of the self-drivers may be omitted. For example, the gamma voltage generator 140 may have a self-driver SD connected to only the gamma voltages that are relatively slow to reach a target voltage, as shown in FIG. 4. In one example, the sixteenth gamma voltage V1920 reaches a target voltage at a relatively slow rate compared to other gamma voltages when the grayscale of the source data input to the data driver 110 changes. In this case, the number of self-drivers is less than the number of amplifiers.

Referring to FIG. 4, the gamma voltage generator 140 outputs the first gamma voltage V0, the second gamma voltage V256 lower than the first gamma voltage V0, the third gamma voltage V512 lower than the second gamma voltage V256, the fourth gamma voltage V768 lower than the third gamma voltage V512, the fifth gamma voltage V1024 lower than the fourth gamma voltage V768, the sixth gamma voltage V1280 lower than the fifth gamma voltage V1024, the seventh gamma voltage V1536 lower than the sixth gamma voltage V1280, the eighth gamma voltage V1792 lower than the seventh gamma voltage V1536, the ninth gamma voltage V1920 lower than the eighth gamma voltage V1792, and the tenth gamma voltage V2048 lower than the ninth gamma voltage V1920.

Voltage levels of the first to eighth and tenth gamma voltages V0 to V1792 and V2048 are determined by the output voltages of the amplifiers AMP1 to AMP9. The ninth gamma voltage V1920 is output from a voltage division node between the eighth gamma voltage V1792 and the tenth gamma voltage V2048 in a resistor row of the second voltage divider RS2, and the peak voltage is suppressed by the pre-driving of the self-driver SD.

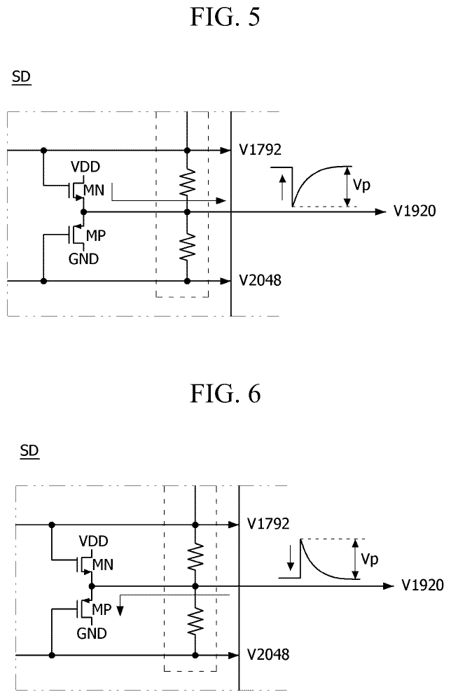

The data voltage Vdata output from the data driver 110 may be lowered when the source data has a higher grayscale value. Then, a peak voltage occurs on the gamma voltage due to a peak current flowing in a gamma voltage wire connected to the DAC 117. The self-drivers S1 to S8 are driven when a peak voltage occurs on the gamma voltage to lower the peak voltage. The pre-driving of these self-drivers S1 to S8 will be described in detail in connection with FIGS. 5 to 7B.

Referring to FIG. 5, the gate-source voltage of the first transistor MN is V1792-V1920. A sharply falling peak voltage Vp may occur on the gamma voltage V1920 when the grayscale value of the source data decreases. For example, when the grayscale value of the source data changes from 2048 to 1920, a falling peak voltage may occur on the gamma voltage V1920 that is output as the data voltage Vdata via the DAC 117. Then, the source voltage of the first transistor MN is lowered. When the source voltage of the first transistor MN becomes lower than the threshold voltage Vthn of the first transistor MN, the gate-source voltage of the first transistor MN becomes greater than the threshold voltage Vthn, and thus the first transistor MN is turned on. As a result, the driving voltage VDD is applied to the gamma voltage 1920 through the turned-on first transistor MN to lower a falling peak voltage Vp. Since the source voltage of the second transistor MP is lowered when the falling peak voltage Vp occurs on the gamma voltage V1920, the second transistor MP is not turned on.

Referring to FIG. 6, the gate-source voltage of the second transistor MP is V2048-V1920. A sharply rising peak voltage Vp may occur on the gamma voltage V1920 when the grayscale value of the source data increases. For example, when the grayscale value of the source data changes from 1792 to 1920, a rising peak voltage may occur on the gamma voltage V1920 that is output as the data voltage Vdata via the DAC 117. Then, the source voltage of the second transistor MP increases. When the source voltage of the second transistor MP increases and thus the gate-source voltage of the second transistor MP becomes smaller than the threshold voltage Vthp, the second transistor MP is turned on. As a result, the peak voltage of the gamma voltage V1920 is discharged to the ground voltage GND through the turned-on second transistor MP, and thus the peak voltage Vp is lowered. When a rising peak voltage Vp occurs on the gamma voltage V1920 occurs, since the source voltage of the first transistor MN is increased, the first transistor MN is not turned on. The first and second transistors MN and MP may not be turned on simultaneously.

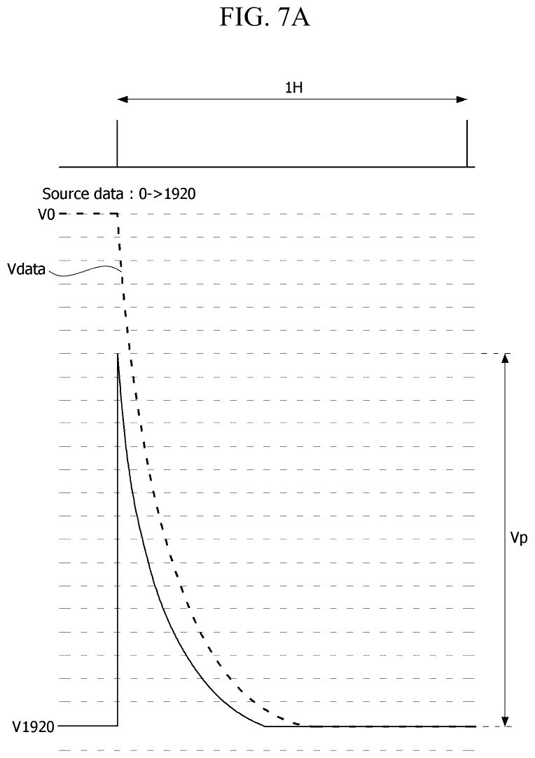

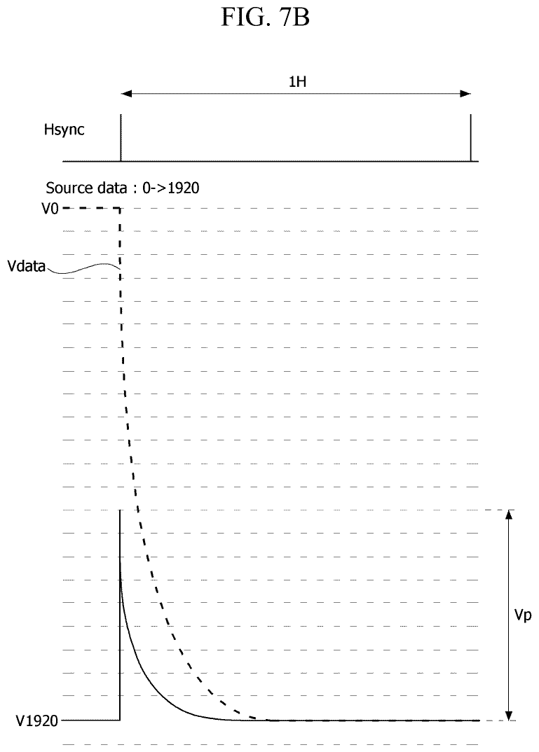

FIG. 7A and FIG. 7B are simulation result diagrams verifying the peak voltage suppression effect of the self-driver along with comparative examples.

FIG. 7A is a simulation result showing the peak voltage Vp of the gamma voltage V1920 in a comparison example without the self-driver SD. In the comparison example, if the resistance value of the voltage divider RS2 decreases or an amplifier is not added, when the grayscale of the source data changes, the time required for the data voltage Vdata to reach a target voltage is limited by the resistor value, resulting in limitations in improving the slew rate of the data voltage Vdata and high constant current consumption when the data voltage Vdata changes.

FIG. 7B is a simulation result where the peak voltage Vp is lowered by connecting the self-driver SD to the gamma voltage V1920. In this simulation, it is verified that the peak voltage of the gamma voltage V1920, which is a target voltage of the grayscale value 1920, is lowered by discharging through the self-driver SD when the grayscale value of the source data rises from 0 to 1920. The pre-driving effect of the self-driver SD enables the data voltage Vdata to quickly reach a target voltage when the grayscale of the source data changes, without the need to reduce the resistance value in the second voltage divider RS2 or to connect an additional amplifier to the gamma voltage V1920. This leads to an improvement in the slew rate. Furthermore, connecting the self-driver SD to the gamma voltage V1920 improves the slew rate of the data voltage without consuming a constant current. In FIG. 7A and FIG. 7B, ‘1H’ is one horizontal period during which the data voltage Vdata is written in one pixel line.

FIG. 8 is a circuit diagram illustrating a third voltage divider of a gamma voltage generator.

Referring to FIG. 8, the gamma voltage generator 140 may further include the third voltage divider RS3, and first and second multiplexers MUX1 and MUX2.

The third voltage divider RS3 includes a plurality of resistors connected in series between a high potential input voltage VREG and a low potential input voltage VREF. The third voltage divider RS3 generates a plurality of voltages with different voltage levels between the high-voltage input voltage VREG and the low-voltage input voltage VREF through voltage division nodes.

The first multiplexer MUX1 selects and outputs one of the high voltage voltages output from the third voltage divider RS3 in response to a preset register value or a Digital Brightness Value DBV generated by the host system 200. The output voltage of the first multiplexer MUX1 is the high potential reference voltage MDBV_TOP transmitted to the first voltage divider RS1 via the first amplifier AMP1.

The second multiplexer MUX2 selects and outputs one of the low voltage voltages output from the third voltage divider RS3 in response to a preset register value or a DBV generated by the host system 200. The output voltage of the second multiplexer MUX2 is the low potential reference voltage MDBV_BOT transmitted to the first voltage divider RS1 via the ninth amplifier AMP9.

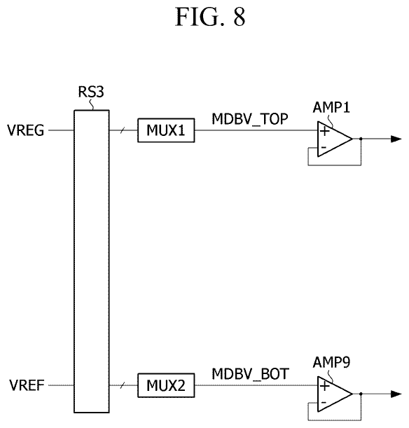

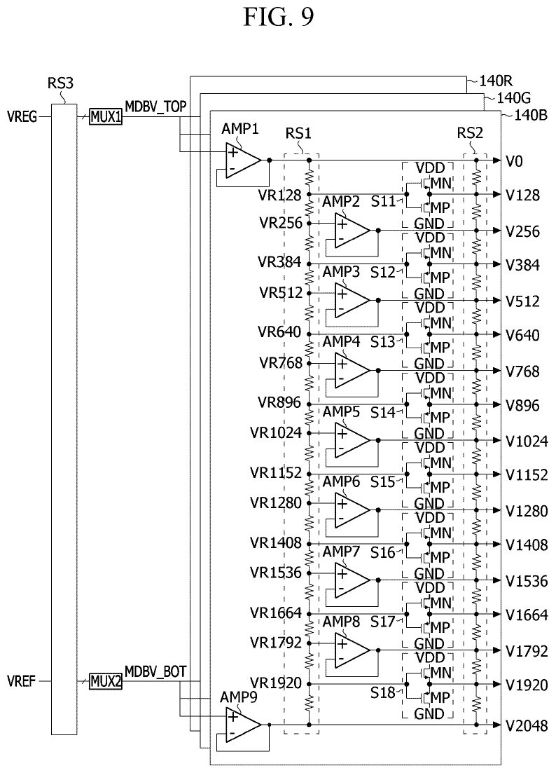

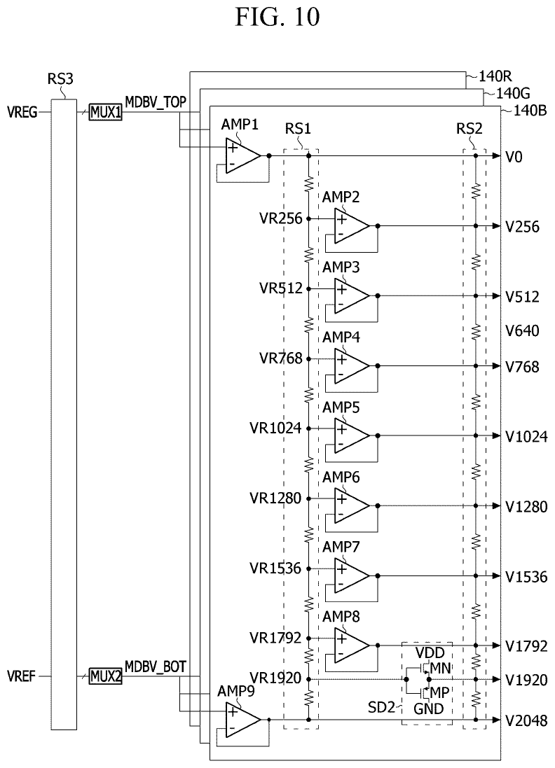

FIGS. 9 and 10 are circuit diagrams illustrating a gamma voltage generator according to another embodiment of the present invention. In FIGS. 9 and 10, components that are substantially the same as in the foregoing embodiment are designated with the same drawing symbols, and a detailed description thereof is omitted.

Referring to FIGS. 9 and 10, the gamma voltage generator 140 includes a first voltage divider RS1, a second voltage divider RS2, a plurality of amplifiers AMP1 to AMP9, and one or more self-drivers S11 to S18. The gamma voltage generator 140 may further include the third voltage divider RS3, and the first and second multiplexers MUX1 and MUX2.

Each of the self-drivers S11 to S18 uses a first and second transistors MN and MP connected between the first voltage divider RS1 and the second voltage divider RS2 to suppress the peak voltage of the (i+1)th gamma voltage between the (i)th gamma voltage and the (i+2)th gamma voltage.

The first transistor MN may be an n-channel transistor and the second transistor MP may be a p-channel transistor. The first transistor MN is turned on when (VRi+1)−(Vi+1)>Vthn. Here VRi+1 is the voltage of the first voltage divider RS1 corresponding to the (i+1)th gamma voltage Vi+1. Vthn is the threshold voltage of the first transistor MN.

The second transistor MP is turned on when (VRi+1)−(Vi+1)<Vthp. Where Vthp is the threshold voltage of the second transistor MP.

The first self-driver S11 is pre-driven when a peak voltage occurs on the second gamma voltage V128 between the first gamma voltage V0 and the third gamma voltage V256 to lower the peak voltage. The first transistor MN includes a gate electrode connected to the voltage VR128 output from a voltage division node of the first voltage divider RS1, a first electrode (drain) connected to the driving voltage VDD, and a second electrode (source) connected to the second gamma voltage V128. When a falling peak voltage occurs on the second gamma voltage V128, the first transistor MN turns on to lower the peak voltage, thereby enabling the second gamma voltage V128 to quickly reach a target voltage. The second transistor MP includes a gate electrode connected to the voltage VR128 output from the voltage division node of the first voltage divider RS1, a first electrode (source) connected to the second gamma voltage V128, and a second electrode connected to the ground voltage GND. When a rising peak voltage occurs on the second gamma voltage V128, the second transistor MP turns on to lower the peak voltage, thereby enabling the second gamma voltage V128 to quickly reach a target voltage.

The first transistor MN of the second self-driver S12 turns on when a falling peak voltage occurs on the fourth gamma voltage V384 to lower the peak voltage. The second transistor MP of the second self-driver S12 turns on when a rising peak voltage occurs on the fourth gamma voltage V384 to lower the peak voltage. The first transistor MN of the third self-driver S13 turns on when a falling peak voltage occurs on the sixth gamma voltage V640 to lower the peak voltage. The second transistor MP of the third self-driver S13 turns on when a rising peak voltage occurs on the sixth gamma voltage V640 to lower the peak voltage.

The first transistor MN of the fourth self-driver S14 turns on when a falling peak voltage occurs on the eighth gamma voltage V896 to lower the peak voltage. The second transistor MP of the fourth self-driver S14 turns on when a rising peak voltage occurs on the eighth gamma voltage V896 to lower the peak voltage. The first transistor MN of the fifth self-driver S15 is turned on when a falling peak voltage occurs on the tenth gamma voltage V1152 to lower the peak voltage. The second transistor MP of the fifth self-driver S15 turns on when a rising peak voltage occurs on the tenth gamma voltage V1152 to lower the peak voltage. The first transistor MN of the sixth self-driver S16 is turned on when a falling peak voltage occurs on the twelfth gamma voltage V1408 to lower the peak voltage. The second transistor MP of the sixth self-driver S16 is turned on when a rising peak voltage occurs on the twelfth gamma voltage V1408 to lower the peak voltage. The first transistor MN of the seventh self-driver S17 is turned on when a falling peak voltage occurs on the fourteenth gamma voltage V1664 to lower the peak voltage. The second transistor MP of the seventh self-driver S17 turns on when a rising peak voltage occurs on the fourteenth gamma voltage V1664 to lower the peak voltage.

The eighth self-driver S18 is pre-driven when a peak voltage occurs on the sixteenth gamma voltage V1920 between the fifteen gamma voltage V1792 and the seventeenth gamma voltage V2048 to lower the peak voltage. The first transistor MN includes a gate electrode connected to the voltage VR1920 output from a voltage division node of the first voltage divider RS1, a first electrode (drain) connected to the driving voltage VDD, and a second electrode (source) connected to the sixteenth gamma voltage V1920. When a falling peak voltage occurs on the sixteenth gamma voltage V1920, the first transistor MN turns on to lower the peak voltage, thereby enabling the sixteenth gamma voltage V1920 to quickly reach a target voltage. The second transistor MP includes a gate electrode connected to the voltage VR1920 output from the voltage division node of the first voltage divider RS1, a first electrode (source) connected to the sixteenth gamma voltage V1920, and a second electrode connected to the ground voltage GND. When a rising peak voltage occurs on the sixteenth gamma voltage V1920, the second transistor MP turns on to lower the peak voltage, thereby enabling the sixteenth gamma voltage V1920 to quickly reach a target voltage.

Some of the self-drivers may be omitted. For example, the gamma voltage generator 140 may have a self-driver SD2 connected to only the gamma voltages that are relatively slow to reach a target voltage, as shown in FIG. 10. In one example, the sixteenth gamma voltage V1920 reaches a target voltage at a relatively slow rate compared to other gamma voltages when the grayscale of the source data input to the data driver 110 changes.

Referring to FIG. 10, the gamma voltage generator 140 outputs the first gamma voltage V0, the second gamma voltage V256 lower than the first gamma voltage V0, the third gamma voltage V512 lower than the second gamma voltage V256, the fourth gamma voltage V768 lower than the third gamma voltage V512, the fifth gamma voltage V1024 lower than the fourth gamma voltage V768, the sixth gamma voltage V1280 lower than the fifth gamma voltage V1024, the seventh gamma voltage V1536 lower than the sixth gamma voltage V1280, the eighth gamma voltage V1792 lower than the seventh gamma voltage V1536, the ninth gamma voltage V1920 lower than the eighth gamma voltage V1792, and the tenth gamma voltage V2048 lower than the ninth gamma voltage V1920.

Voltage levels of the first to eighth and tenth gamma voltages V0 to V1792 and V2048 are determined by the output voltages of the amplifiers AMP1 to AMP9. The ninth gamma voltage V1920 is output from a voltage division node between the eighth gamma voltage V1792 and the tenth gamma voltage V2048 in a resistor row of the second voltage divider RS2, and the peak voltage is suppressed by the pre-driving of the self-driver SD2.

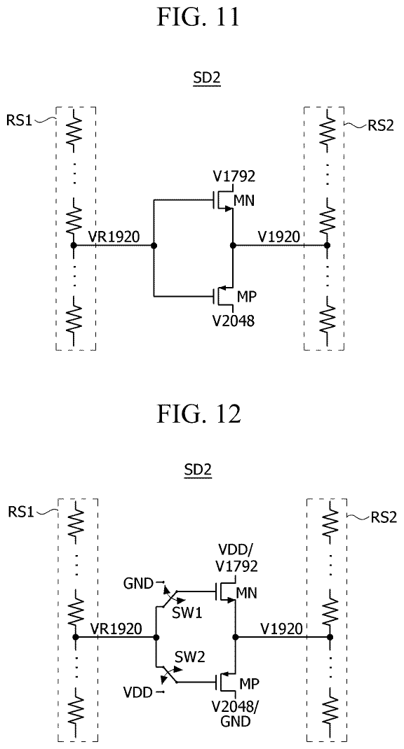

The driving voltages applied to the self-drivers S11 to S18 may be varied as shown in FIG. 11.

Referring to FIG. 11, the first transistor MN includes a gate electrode connected to a voltage division node of the first voltage divider RS1, a first electrode connected to the (i)th gamma voltage higher than the (i+1)th gamma voltage, and a second electrode connected to the (i+1)th gamma voltage corresponding to the voltage output from the voltage division node. The second transistor MP includes a gate electrode connected to the voltage division node of the first voltage divider RS1, a first electrode connected to the (i+1)th gamma voltage, and a second electrode connected to the (i+2)th gamma voltage lower than the (i+1)th gamma voltage.

The (i)th gamma voltage higher than the (i+1)th gamma voltage may be applied to the first electrode of the first transistor MN, and an (i+2)th gamma voltage lower than the (i+1)th gamma voltage may be applied to the second electrode of the second transistor MP. For example, in the self-driver SD2 for suppressing the peak voltage of the gamma voltage V1920, the gamma voltage V1792 may be applied to the first electrode of the first transistor MN and the gamma voltage V2048 may be applied to the second electrode of the second transistor MP.

The self-drivers S11 to S18, SD2 may be selectively disabled. For this purpose, switch elements SW1 and SW2 may be connected to the gate electrodes of the first and second transistors MN and MP, respectively, as shown in FIG. 12. Each of the switch elements SW1 and SW2 may be implemented as a CMOS transistor. The switch elements SW1 and SW2 may be controlled by any one of the host system 200, the timing controller 130, and the logic controller 112. When a customer or user does not want to use the self-driver feature, the self-drivers S11 to S18, SD2 may be disabled using the first and second switch elements SW1 and SW2 by setting registers (or memory). For example, if the customer has an EMI issue due to excessive transition speed of the gamma voltage and data voltage caused by the self-driver depending on the system, the customer may disable the self-driver S11 to S18, SD2 to slow down the transition speed.

When the first switch element SW1 connects the gate electrode of the first transistor MN to the ground voltage GND, the first transistor MN remains in the off state. When the first switch element SW1 makes the connection of the gate electrode of the first transistor MN as shown in FIGS. 3, 4, 9, and 10, the first transistor MN may be turned on based on changes in the gamma voltage V1920.

When the first switch element SW1 connects the gate electrode of the first transistor MN to the ground voltage GND, the first transistor MN remains in the off state. When the first switch element SW1 connects the gate electrode of the first transistor MN as shown in FIGS. 3, 4, 9, and 10, the first transistor MN may be turned on based on changes in the gamma voltage V1920. When the second switch element SW2 connects the gate electrode of the second transistor MP to the driving voltage VDD, the second transistor MP remains in the off state. When the second switch element SW2 makes the connection of the gate electrode of the second transistor MP as shown in FIGS. 3, 4, 9, and 10, the second transistor MP may be turned on based on changes in the gamma voltage V1920.

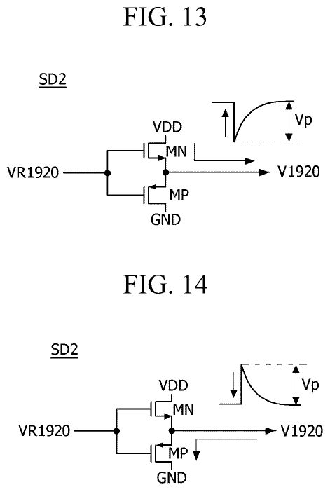

The pre-driving of the self-drivers S11 to S18, SD2 will now be described in detail with reference to FIGS. 13 to 15.

Referring to FIG. 13, the gate-source voltage of the first transistor MN is VR1920-V1920. A sharply falling peak voltage Vp may occur on the gamma voltage V1920 when the grayscale value of the source data decreases. Then, the source voltage of the first transistor MN is lowered. When the source voltage of the first transistor MN becomes lower than the threshold voltage Vthn of the first transistor MN, the gate-source voltage of the first transistor MN becomes greater than the threshold voltage Vthn, and thus the first transistor MN is turned on. As a result, the driving voltage VDD is applied to the gamma voltage 1920 through the turned-on first transistor MN to lower a falling peak voltage Vp. Since the source voltage of the second transistor MP is lowered when the falling peak voltage Vp occurs on the gamma voltage V1920, the second transistor MP is not turned on.

Referring to FIG. 14, the gate-source voltage of the second transistor MP is VR1920-V1920. A sharply rising peak voltage Vp may occur on the gamma voltage V1920 when the grayscale value of the source data increases. For example, when the grayscale value of the source data changes from 1792 to 1920, a rising peak voltage may occur on the gamma voltage V1920 that is output as the data voltage Vdata via the DAC 117. Then, the source voltage of the second transistor MP increases. When the source voltage of the second transistor MP increases and thus the gate-source voltage of the second transistor MP becomes smaller than the threshold voltage Vthp, the second transistor MP is turned on. As a result, the peak voltage of the gamma voltage V1920 is discharged to the ground voltage GND through the turned-on second transistor MP, and thus the peak voltage Vp is lowered. When a rising peak voltage Vp occurs on the gamma voltage V1920 occurs, since the source voltage of the first transistor MN is increased, the first transistor MN is not turned on.

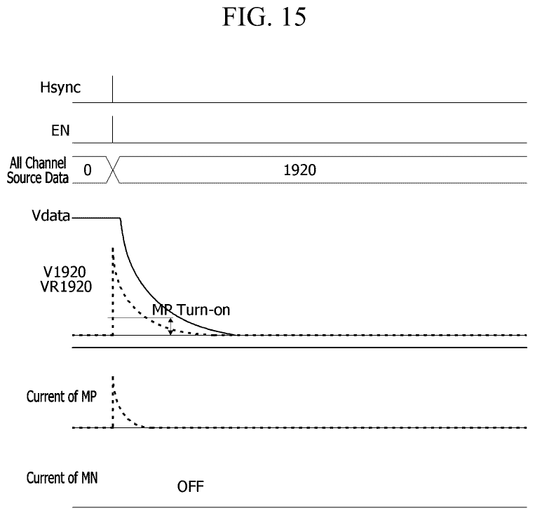

FIG. 15 is a simulation result diagram verifying the peak voltage suppression effect of the self-driver shown in FIGS. 9 and 10. In this simulation, it is verified that the peak voltage of the gamma voltage V1920 is lowered by discharging through the self-driver SD2 when the grayscale value of the source data rises from 0 to 1920 in all channels of the data driver 110. As may be seen from this simulation result, when the second transistor MP is driven, the first transistor MN remains off state and no current flows. In FIG. 15, “EN” is an output enable signal that controls the output timing of the second latch 115 of the data driver 110.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

### INDUSTRIAL APPLICABILITY

The present invention can reduce the circuit size of a gamma voltage generation circuit and a source driver circuit and improve heat generation, power consumption, and settling time.

1. A gamma voltage generation circuit comprising:
a first voltage divider configured to output a plurality of voltages having different voltage levels between a high potential reference voltage and a low potential reference voltage;
a plurality of amplifiers configured to transmit the voltages output from the first voltage divider to output terminals of the amplifiers as gamma voltages;
a second voltage divider connected between the high potential reference voltage and the low potential reference voltage and connected to the output terminals of the amplifiers; and
one or more self-drivers connected to the second voltage divider to adjust at least one of gamma voltages other than the gamma voltages output from the amplifiers,
wherein the self-drivers include a first transistor and a second transistor connected in series.

2. The gamma voltage generation circuit according to claim 1, wherein the first transistor is an n-channel transistor and the second transistor is a p-channel transistor.

3. The gamma voltage generation circuit according to claim 2, wherein the first transistor includes a gate electrode connected to an (i)th gamma voltage, a first electrode connected to a driving voltage, and a second electrode connected to an (i+1)th gamma voltage, where i is a natural number, and
wherein the second transistor includes a gate electrode connected to an (i+2)th gamma voltage, a first electrode connected to the (i+1)th gamma voltage, and a second electrode connected to a ground voltage.

4. The gamma voltage generation circuit according to claim 3, wherein the (i)th gamma voltage is higher than the (i+1)th gamma voltage, and
wherein the (i+2)th gamma voltage is lower than the (i+1)th gamma voltage.

5. The gamma voltage generation circuit according to claim 2, wherein the first transistor includes a gate electrode connected to a voltage division node of the first voltage divider, a first electrode connected to a driving voltage, and a second electrode connected to an (i+1)th gamma voltage corresponding to a voltage output from the voltage division node, where i is a natural number, and
wherein the second transistor includes a gate electrode connected to the voltage division node of the first voltage divider, a first electrode connected to the (i+1)th gamma voltage, and a second electrode connected to a ground voltage.

6. The gamma voltage generation circuit according to claim 2, wherein the first transistor includes a gate electrode connected to a voltage division node of the first voltage divider, a first electrode connected to an (i)th gamma voltage, and a second electrode connected to an (i+1)th gamma voltage corresponding to a voltage output from the voltage division node, where i is a natural number, and
wherein the second transistor includes a gate electrode connected to the voltage division node of the first voltage divider, a first electrode connected to the (i+1)th gamma voltage, and a second electrode connected to an (i+2)th gamma voltage.

7. The gamma voltage generation circuit according to claim 5, wherein the (i)th gamma voltage is higher than the (i+1)th gamma voltage, and wherein the (i+2)th gamma voltage is lower than the (i+1)th gamma voltage.

8. The gamma voltage generation circuit according to claim 3, further comprising:
a first switch element connected to the gate electrode of the first transistor to selectively disable the first transistor; and
a second switch element connected to the gate electrode of the second transistor to selectively disable the second transistor.

9. A source driver circuit comprising:
a data driver configured to convert source data to data voltages based on gamma voltages; and
a gamma voltage generator configured to generate the gamma voltages,
wherein the gamma voltage generator includes:
a first voltage divider configured to output a plurality of voltages having different voltage levels between a high potential reference voltage and a low potential reference voltage;
a plurality of amplifiers configured to transmit the voltages output from the first voltage divider to output terminals of the amplifiers as gamma voltages;
a second voltage divider connected between the high potential reference voltage and the low potential reference voltage and connected to the output terminals of the amplifiers; and
one or more self-drivers connected to the second voltage divider to adjust at least one of gamma voltages other than the gamma voltages output from the amplifiers,
wherein the self-drivers include a first transistor and a second transistor connected in series.

10. The source driver circuit according to claim 9, wherein the first transistor is an n-channel transistor and the second transistor is a p-channel transistor.

11. The gamma voltage generation circuit according to claim 6, wherein the (i)th gamma voltage is higher than the (i+1)th gamma voltage, and
wherein the (i+2)th gamma voltage is lower than the (i+1)th gamma voltage.

12. The gamma voltage generation circuit according to claim 5, further comprising:
a first switch element connected to the gate electrode of the first transistor to selectively disable the first transistor; and
a second switch element connected to the gate electrode of the second transistor to selectively disable the second transistor.

13. The gamma voltage generation circuit according to claim 6, further comprising:
a first switch element connected to the gate electrode of the first transistor to selectively disable the first transistor; and
a second switch element connected to the gate electrode of the second transistor to selectively disable the second transistor.
